(19) United States
(12) Patent Application Publication
(10) Pub. No.: US 2020/0380625 A1
(43) Pub. Date: Dec. 3, 2020

(54) A METHOD OF INNOVATION

(71) Applicant: BELLATOR PTY LTD, Brisbane, Queensland (AU)

(72) Inventor: Dale Watson, Mosman, NSW (AU)

(21) Appl. No.: 16/642,880

(22) PCT Filed: Jul. 16, 2018
(86) PCT No.: PCT/AU2018/050738

§ 371 Date: Feb. 27, 2020

(30) Foreign Application Priority Data
Jul. 14, 2017 (AU) 2017204897
Jul. 14, 2017 (AU) 2017902766
Dec. 2, 2017 (AU) 2017101681

(51) Int. Cl. G06Q 50/18; G06Q 10/06; G06Q 10/10

(52) U.S. Cl. CPC G06Q 50/184; G06Q 10/10; G06Q 10/06375

(57) ABSTRACT

A method of providing innovation services to a business or other organization includes the steps of an innovation services provider engaging with the business or organization to determine the improvement, describing or defining an IP right relating to an improvement to one or more processes, equipment or systems of the business or other organization and specifying a financial return to an innovation services provider for the improvement. The amount of the return is determined, at least partially, from the value or benefit or advantage of any sort to the business or other organization of the IP right as described or defined.

### FIELD OF THE INVENTION

The present invention broadly relates to the field of innovation. More specifically it relates to, but is not limited to, business or organisational innovation. More specifically still it relates to, but is not limited to, business or organisational consulting. Yet more specifically still it relates to, but is also not limited to, the provision of Intellectual Property (‘IP’) services for at least these purposes.

### BACKGROUND OF THE INVENTION

IP rights can be, and typically are, expensive to define and otherwise secure. These rights comprise, for example, registered IP rights including those comprising patent, trademark and design law. For these reasons, in some cases IP owners or originators apply for corresponding registered IP rights themselves. This has cost benefits but can, for example, at least contribute to problems or difficulties in the applications, or deficiencies in any registered IP rights that may be obtained.

IP rights are typically also expensive to enforce.

Typically, advisors, for example, patent attorneys and patent lawyers, are engaged in relation to IP rights. With respect to registered IP rights services provided by these professionals include, for example, preparation and filing of patent applications applying for corresponding registered IP rights. Advisors are typically similarly used in relation to other registered IP, for example, registered IP comprising trademarks and designs.

Generally, IP rights and in particular registered IP rights, are typically best sought prior to commercialisation. In some cases, for example patentable IP, it is also typically necessary or at least beneficial to apply for corresponding registered IP rights prior to commercialisation.

Applying for or obtaining IP rights, and the corresponding commercialisation, is typically also complex and uncertain. It is also typically difficult to compare services or advice provided by IP advisors and their charges.

It is therefore desirable to provide alternative means of innovating and defining or otherwise securing IP rights which in at least one aspect at least partly addresses one or more of these possible shortcomings.

### SUMMARY OF THE INVENTION

In one aspect of the present invention there is provided a method of providing innovation services to a business or other organisation comprising the steps of describing or defining an IP right relating to an improvement to one or more processes, equipment or systems of said business or other organisation and specifying a financial return to an innovation services provider for said improvement, wherein the amount of said financial return is determined, at least partially, from the value or benefit or advantage of any sort or any other consideration or value of any kind to said business or other organisation of said IP right as said described or defined.

Preferably, said method of said one aspect of the present invention further comprising the step of said innovation services provider engaging with said business or organisation to determine said improvement. More preferably, said engagement step further comprises said business or other organisation disclosing one or more its processes, equipment or systems, for example, to said innovation services provider for the purpose of said innovation services provider identifying one or more improvements to these. More preferably still, said method further comprising the step of said innovation services provider applying innovation expertise to said one or more processes, equipment or systems. Yet more preferably, said method of said one aspect of the present invention further comprises the step of said innovation services provider inventing said improvement.

In one preferred form of said present invention said innovation services provider comprises, for example, a consulting business or organisation. More preferably said step of describing or defining corresponding IP right further comprises the step of obtaining IP services in relation to said one or more improvements. More preferably still, this further step further comprises the step of forming an agreement between said innovation services provider and an IP services provider relating to said provision of IP services by said IP services provider in relation to said one or more improvements. Such an agreement may, for example, be one off agreement or could alternatively comprise joint venture agreement or any other form of agreement. Preferably, said IP services provider does not charge for said IP services in which case financial returns for those services are derived directly from said financial return to said innovation services provider. However, in another alternative form said IP services are provided “in-house”. This other alternative form of the present invention comprises an innovation services provider having IP services provision capability.

In an alternative form of the present invention said innovation services provider at least partially comprises, for example, a traditional IP services provider, for example a patent firm or law firm providing IP services. In this alternative form of the present invention said innovation services provider further comprises, in addition to said traditional IP services provision capability, innovation or consulting service provision capability. The innovation or consulting services may, for example, be provided by agreement between said innovation services provider and an innovation or consulting services provider. Such an agreement may, for example, be one off agreement or could alternatively comprise joint venture agreement or any other form of agreement. Preferably, said innovation or consulting services provider does not charge for their innovation or consulting services in which case financial returns for those services are derived directly from said financial return to said innovation services provider. However, alternatively said innovation or consulting services provision capability may be provided “in-house”. This other alternative form of said innovation services provider of the present invention therefore at least substantially comprises a traditional IP services provider also having innovation or consulting services provision capability.

Preferably, said step of describing or defining corresponding IP right comprises preparing a patent application. More preferably, said step of preparing said patent application further comprises the step of filing it with one or more patent offices or equivalent organisations to obtain an official filing date prior to its disclosure, or the disclosure of said improvement, to said business or other organisation.

Preferably, said method further comprises the step of describing or defining said IP right in the name of said innovation services provider so that said innovation services provider owns said IP right.

In one preferred form of said one aspect of the present invention, said step of said innovation services provider agreeing with said business or other organisation comprises, for example, one or more of the following: a heads of agreement; a joint venture agreement; and a framework agreement which stipulates or guides specific requirements of said agreement relating to different said processes, equipment or systems.

In another aspect of the present invention there is provided a method of a business or other organisation obtaining innovation services comprising the steps of describing or defining an IP right relating to an improvement to one or more processes, equipment or systems of said business or other organisation and specifying a financial return to an innovation services provider for said improvement, wherein the amount of said financial return is determined, at least partially, from the value or benefit or advantage of any sort or any other consideration or value of any kind to said business or other organisation of said IP right as said described or defined.

Preferably, said method of said other aspect of the present invention further comprises the step of said business or other organisation engaging said innovation services provider to determine said improvement. More preferably, said engagement further comprises said business or other organisation disclosing one or more of its processes, equipment or systems to said innovation services provider for the purpose of said innovation services provider identifying one or more improvements to these. More preferably still, said method further comprising the step of said innovation services provider applying their innovation expertise to said one or more processes, equipment or systems. Yet more preferably, said method of said other aspect of the present invention further comprises the step of said innovation services provider inventing said improvement.

Preferably, said innovation services provider of said other aspect of the present invention are as defined in relation to said one aspect of the present invention.

In one preferred form of said other aspect of the present invention, said step of said business or other organisation agreeing with said innovation services provider comprises, for example, one or more of the following: a heads of agreement; a joint venture agreement; and a framework agreement which stipulates or guides specific requirements of said agreement relating to different said processes, equipment or systems.

In a yet another aspect of the present invention there is provided an IP right description or definition relating to an improvement to one or more processes, equipment or systems of a business or other organisation, said improvement being that of an innovation service provider providing, or proposing to provide, innovation services to said business or other organisation, said IP right description or definition being, at least partially, for the purpose of specifying a financial return to said innovation services provider for said improvement, wherein the amount of said financial return is determined, at least partially, from the value or benefit or advantage of any sort or any other consideration or value of any kind to said business or other organisation of said IP right as said described or defined.

In a still other aspect of the present invention there is provided an agreement between an innovation services provider and a business or other organisation, said agreement relating at least partially to one or more processes, equipment or systems of said business or other organisation that said innovation services provider is providing, or proposing to provide, innovation services in relation to, said agreement referencing an IP right description or definition relating to an improvement to said one or more processes, equipment or systems, said improvement being that of said innovation service provider and said IP right description or definition being, at least partially, for the purpose of specifying a financial return to said innovation services provider for said improvement, wherein the amount of said financial return is determined, at least partially, from the value or benefit or advantage of any sort or any other consideration or value of any kind to said business or other organisation of said IP right as said described or defined.

Preferably, said innovation services provider of said yet another and still other aspects of the present invention comprises said innovation services provider of said one aspect of the present invention.

Preferably, said IP right description or definition of said one, other, yet other and still other aspects of the present invention comprises a patent application. More preferably, it comprises a patent application that has been filed with one or more patent offices or equivalent organisations to obtain an official filing date. Still more preferably, said patent application is filed in the name of said innovation services provider.

All prior art disclosures referenced directly or indirectly in the present specification, and any related documents, acts, materials, devices, articles, methods or the like, is solely for the purpose of providing context for the present invention. It is not to be taken as an admission that any or all of what is disclosed in relation to these disclosures forms part of the prior art base or was common general knowledge in the field relevant to the present invention as it existed in Australia or elsewhere before the priority date of each claim of the present specification.

### BRIEF DESCRIPTION OF THE DRAWINGS

Preferred embodiments of the present invention will now be described, by way of example only, with reference to the accompanying drawings in which:

FIG. 1 is a schematic diagram showing one example of each of an innovation services provider of the present invention and a business that it provides, or wishes to provide, innovation services to, and examples, in accordance with the present invention, of interactions of these two entities.

### DETAILED DESCRIPTION OF THE PREFERRED EMBODIMENT

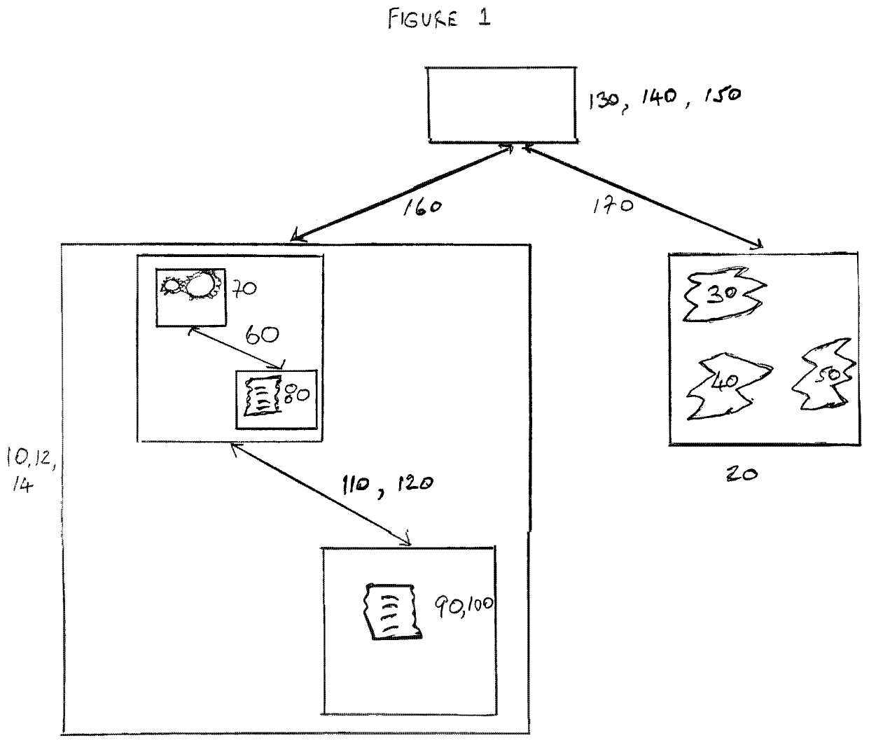

Referring to FIG. 1, one example of a method of providing innovation services to a business or other organisation is disclosed. In this particular example the consulting business of said one aspect of the present invention comprises Innovate Pty Ltd 10. Innovate Pty Ltd 10, in this particular example is hopeful of providing its services to a business or other organisation of said one aspect of the present invention which in this particular example comprises component manufacturer, Best Parts Pty Ltd 20. Best Parts Pty Ltd 20 has agreed 130 to disclose, in confidence, its processes 30, equipment 40 and systems 50 to Innovate Pty Ltd 10 in the hope that this company will be able to help it reduce costs and therefore increase profit.

In accordance with an agreement 130 Innovate Pty Ltd 10 inspects Best Parts Pty Ltd 20 manufacturing plant 160 and has a series of meetings with manufacturing engineers of Best Parts Pty Ltd 20. Following the site visit and meetings Innovate Pty Ltd 10 redesigns 70 some of the processes 30, equipment 40 and systems 50 to improve efficiency and effectiveness. Some of their redesign actually comprises alternative processes and equipment. The redesign is documented 80 and before meeting again with Best Parts Pty Ltd 20 Innovate Pty Ltd 10 engages 110 a patent firm that it usually uses to, in accordance with said one aspect of the present invention, describe or define corresponding IP right relating to the documented redesign 80. In this particular example the patent firm determines that aspects of the documented redesign 80 are in their opinion patentable and they draft corresponding provisional patent applications 90. The patent applications 90 are filed with the Australian patent office and then Innovate Pty Ltd 10 arranges a meeting 170 with Best Parts Pty Ltd 20 to discuss their documented redesign 80.

During the meeting Best Parts Pty Ltd 20 indicate that they are very pleased with the documented redesign 80. In accordance with the agreement 130, Innovate Pty Ltd 10 and Best Parts Pty Ltd 20 therefore agree that their respective lawyers will together draft an agreement 140 to define a financial return of said one aspect of the present invention to Innovate Pty Ltd 10 which in this particular example comprises a percentage of the value of the redesign to Best Parts Pty Ltd 20.

Referring again to FIG. 1, another example of a method of providing innovation services to a business or other organisation is disclosed. This other example is identical to the example described above with the following exceptions. Innovation Services Pty Ltd 12 is one particular example, in place of Innovate Pty Ltd 10, of the consulting business of said one aspect of the present invention. Innovation Services Pty Ltd 12 provide similar services to those of Innovate Pty Ltd 10 and in this particular example also provide those services to Best Parts Pty Ltd 20. However, Innovation Services Pty Ltd 12 has an integrated IP department and as such the IP services that Innovate Pty Ltd 10 obtained from a patent firm are provided “in-house” 120. These IP related services 120 that Innovation Services Pty Ltd 12 has access to internally is one example of said one aspect of the present invention of IP services being provided and not charged for. There is obviously a cost to Innovation Services Pty Ltd 12 for having these IP related services 120 “in-house” but this cost is offset by financial returns that Innovation Services Pty Ltd 12 receives by virtue of its agreement 140 with Best Parts Pty Ltd 20.

FIG. 1 also discloses yet another example of said innovation services provider of said one aspect of the present invention. Referring to FIG. 1, Best IP Services Pty Ltd 14 provide one example of said traditional IP services provider of said one aspect of the present invention and are said innovation services provider. In relation to this yet other example, Best IP Services Pty Ltd 14 provide the same services as those of Innovation Services Pty Ltd 12. However, the core business of Best IP Services Pty Ltd 14, contrary to that of Innovation Services Pty Ltd 12, was historically the provision of IP services. Best IP Services Pty Ltd 14 recognised however that there was more value in the IP that they were providing services in relation to than what they could charge for on an hourly basis. They also recognised that it was a win-win for business such as Best Parts Pty Ltd 20 if those business paid for their innovations, both design and IP related expenses, from the benefits to them of those innovations. Best IP Services Pty Ltd 14 therefore hired inventors and entrepreneurs to provide the part of their business that corresponds to said innovation services provider of said one aspect of the present invention. In this example therefore the innovation services component of Best IP Services Pty Ltd 14 is provided “in-house”.

Considering Best IP Services Pty Ltd 14, an alternative example comprises the provision of innovation services in a corresponding manner to that of Innovate Pty Ltd 10 obtaining IP services. In this alternative example Best IP Services Pty Ltd 14 therefore engages 110 innovation consultants, including inventors and entrepreneurs, 100 to act in a consulting capacity for Best IP Services Pty Ltd 14 and thereby be said innovation services provider of said one aspect of the present invention.

FIG. 1 also discloses an example of said other aspect of the present invention. In relation to said other aspect of the present invention Best Parts Pty Ltd 20 is one example of said business or other organisation which obtains innovation services according to said method of said other aspect of the present invention. In this other example, Best Parts Pty Ltd 20 interact with innovation service providers as it does in relation to the examples above comprising Innovate Pty Ltd 10, Innovation Services Pty Ltd 12 and Best IP Services Pty Ltd 14 and has corresponding respective agreements 150 corresponding to agreements 130 and 140 described above. The only difference is that in this example Best Parts Pty Ltd 20 pursues an innovation services provider of said one and other aspects of the present invention. Another difference can comprise Best Parts Pty Ltd 20 directly engaging an IP services provider, rather than via, for example, Innovate Pty Ltd 10, Innovation Services Pty Ltd 12 or Best IP Services Pty Ltd 14. IP services providers engaged in this way by Best Parts Pty Ltd 20 could be engaged, for example, in a corresponding manner to the examples included above in relation to Innovate Pty Ltd 10, Innovation Services Pty Ltd 12 and Best IP Services Pty Ltd 14. They could however alternatively be engaged directly by Best Parts Pty Ltd 20 in a traditional manner which involves Best Parts Pty Ltd 20 paying directly for corresponding IP services.

In accordance with said other aspect of the present invention innovation Best Parts Pty Ltd 20 is therefore empowered to outsource its innovation and thereby have advantages corresponding to those of businesses that have internal R & D and IP services. However, the present invention also enables business like Best Parts Pty Ltd 20 to obtain these advantages without the corresponding costs. It also enables Best Parts Pty Ltd 20 and business or companies like it to take risks with R & D and corresponding IP protection with relatively small corresponding costs. For example, in some cases, in accordance with the present invention, the only costs might be the investment of personnel in innovation projects that requires them to work for short periods of time with personnel from companies or businesses like Innovate Pty Ltd 10, Innovation Services Pty Ltd 12 and Best IP Services Pty Ltd 14. This reduction in risk and also cost is likely to be beneficial in driving innovation.

It will be appreciated that the invention in at least one of its preferred forms has at least the following possible advantages:
1. It enables a business or other organisation to innovate without costs relating to the associated IP;
2. It enables inventors and entrepreneurs to apply their skills to a business or other organisation to improve processes, equipment or systems of those businesses or other organisations. This makes their innovation and entrepreneurship more targeted and therefore more efficient and effective;
3. It enables at least some of the costs to a business or other organisation associated with innovation, for example those traditionally relating to consulting or IP protection or enforcement, to be paid directly from revenue generated by the innovation;
4. It enables a business or other organisation that does not have significant “in-house” innovation or IP protection or enforcement capability to innovate in a similar way as businesses or other organisations that do have such “in-house” capability;
5. It enables traditional consulting businesses to charge on the basis of the value or benefit of their contribution rather than their traditional means of charging, for example, an hourly, daily or yearly rate or project based charging;
6. It enables traditional IP services provider, for example a patent or IP law firm to charge on the basis of the value or benefit of the innovation they are providing services in relation to rather than their traditional means of charging, for example, an hourly, daily or yearly rate or project based charging; and
7. It provides an alternative means of providing IP services to the traditional means and enables IP services to be provided without patent firms or IP law firms as historically has been the case for more than 70 years.

It will be appreciated by persons skilled in the art that numerous variations or modifications may be made to the invention as shown in the specific embodiments without departing from the spirit or scope of the invention as broadly described. For example, said innovation services provider is one example of a third party providing innovation services to said business or other organisation for the propose of improving any aspect of that business or organisation. However, the third party engaged to improve, or simply offering to improve, processes, equipment or systems, for example, could simply comprise, for example, an individual. Such an individual may or may not already have experience as an inventor or entrepreneur. Furthermore, the business or other organisation for which the improvement is developed or invented could itself, for example, comprise a business consulting company. In another alternative example said financial return to either said innovation services provider or said IP services provider or both could, for example, comprise any form of consideration. In a still other alternative example said financial return is specified in an agreement between said innovation services provider and said business or other organisation. In a yet another example, said financial return is calculated substantially, rather than at least partially, from the value or benefit or advantage of any sort or any other consideration or value of any kind to said business or other organisation of said IP right. The present embodiments are, therefore, to be considered in all respects as illustrative and not restrictive.

1-48. (canceled)

49. A method of innovation comprising the steps of an organization disclosing aspects of the organization to an innovation services provider to innovate and specifying a financial return to said innovation services provider for a corresponding innovation, wherein said innovation services provider describes or defines or describes and defines said innovation as a corresponding IP right prior to its disclosure to said organization and the amount of said financial return is determined, at least partially, from the value or benefit or advantage of any sort or any other consideration or value of any kind to said organization of said IP right.

50. A method as claimed in claim 49 further comprising the step of said innovation services provider applying innovation expertise in relation to said disclosure.

51. A method as claimed in claim 50 further comprising the step of innovating.

52. A method as claimed in claim 51 wherein said step of describing or defining or describing and defining said innovation as a corresponding IP right further comprises the step of obtaining IP services in relation to said innovation.

53. A method as claimed in claim 52 wherein said innovation services provider comprises an IP services provider providing said IP services.

54. A method as claimed in claim 49 wherein said step of describing or defining or describing and defining said innovation as a corresponding IP right further comprises preparing a patent application.

55. A method as claimed in claim 54 further comprising the step of filing said patent application with one or more patent offices or equivalent organizations to obtain an official filing date prior to its disclosure, or the disclosure of said innovation, to said organization.

56. A method as claimed in claim 55 further comprising the step of describing or defining or describing and defining said innovation as a corresponding IP right in the name of said innovation services provider so that said innovation services provider owns said IP right.

57. A method as claimed in claim 56 further comprising the step of specifying an amount of said financial return in an agreement.

58. An IP right description or definition or description and definition deriving from a method of innovation of claim 49.

59. An IP right description or definition or description and definition deriving from a method of innovation of claim 54.

60. An IP right description or definition or description and definition deriving from a method of innovation of claim 55.

61. An IP right description or definition or description and definition deriving from a method of innovation of claim 56.

62. An agreement deriving from the method of innovation of claim 49 comprising said IP right description or definition or description and definition.

63. An agreement deriving from the method of innovation of claim 54 comprising said IP right description or definition or description and definition.

64. An agreement deriving from the method of innovation of claim 55 comprising said IP right description or definition or description and definition.

65. An agreement deriving from the method of innovation of claim 56 comprising said IP right description or definition or description and definition.
